(19) United States
(12) Patent Application Publication
(10) Pub. No.: US 2012/0197811 A1
(43) Pub. Date: Aug. 2, 2012

(54) MECHANISM TO ALLOW CUSTOM IMPLEMENTATIONS TO MANAGE PRODUCT ASSETS AS SPECIFIED BY A THIRD PARTY

(76) Inventors: Bryan Michael Kearney, Raleigh, NC (US); Devan C. Goodwin, Halifax (CA)

(21) Appl. No.: 13/018,633

(22) Filed: Feb. 1, 2011

(51) Int. Cl. G06Q 10/00

(52) U.S. Cl. 705/304

(57) ABSTRACT

A server detects a product asset management request relating to custom product business model data of a third party during execution of a product asset management engine, wherein the request is associated with at least one extension point. The third party is a third party to a developer of the product asset management engine. The server obtains the custom product business model data by executing a call for an extension relating to the at least one extension point and provides the custom product business model data to a client to service the product asset management request to allow the third party to manage product assets as specified by the third party.

### TECHNICAL FIELD

Embodiments of the present invention relate to product asset management. Specifically, the embodiments of the present invention relate to allowing custom implementations to manage product assets as specified by a third party.

### BACKGROUND

A software provider can sell software and/or service products, for example, by selling subscriptions to customers for products. An entity that has purchased a product subscription is an owner of the subscription and has a right to use the product for the period of the subscription. An owner's use of a subscription can be represented, for example, as an ‘entitlement.’ For example, a customer, such as ACME Company, purchases ten 3-year subscriptions to Enterprise Software ABC. ACME Company is the owner of the ten subscriptions, which can be represented by ten entitlements, and can assign the ten entitlements to various systems. When a system is granted an entitlement, the system can receive product updates for the Enterprise Software ABC.

Product asset management tools are provided to allow software providers and customers to manage the product subscriptions that have been purchased, the subscriptions that have been consumed, the patches, updates, and maintenance of the products, etc. Conventional product asset management tools, however, are typically hard-coded to support a specific product business model and a particular set of product offerings, and do not offer flexibility in what can be managed.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is an exemplary network architecture in which embodiments of the present invention may operate.

FIG. 2A is a block diagram of one embodiment of a product asset management engine.

FIG. 2B illustrates a portion of an exemplary extension interface.

FIG. 3 is a flow diagram of an embodiment of a method for allowing custom implementations to manage product assets as specified by a third party.

FIG. 4 is a diagram of one embodiment of a computer system for allowing custom implementations to manage product assets as specified by a third party.

### DETAILED DESCRIPTION

Embodiments of the invention are directed to a method and system for allowing custom implementations to manage product assets as specified by a third party. A server detects a product asset management request relating to custom product business model data of a third party during execution of a product asset management engine, wherein the request is associated with at least one extension point. The third party is a third party to a developer of the product asset management engine. The server obtains the custom product business model data by executing a call for an extension relating to the at least one extension point and provides the custom product business model data to a client to service the product asset management request to allow the third party to manage product assets as specified by the third party.

Conventional product asset management tools are hard-coded to support a specific product business model and do not offer flexibility in what can be managed. Embodiments of the present invention provide an engine, which third parties, such as independent software vendors (ISV) and customers, can expand upon and customize, according to the business models of the third parties, for managing product assets as specified by the third parties.

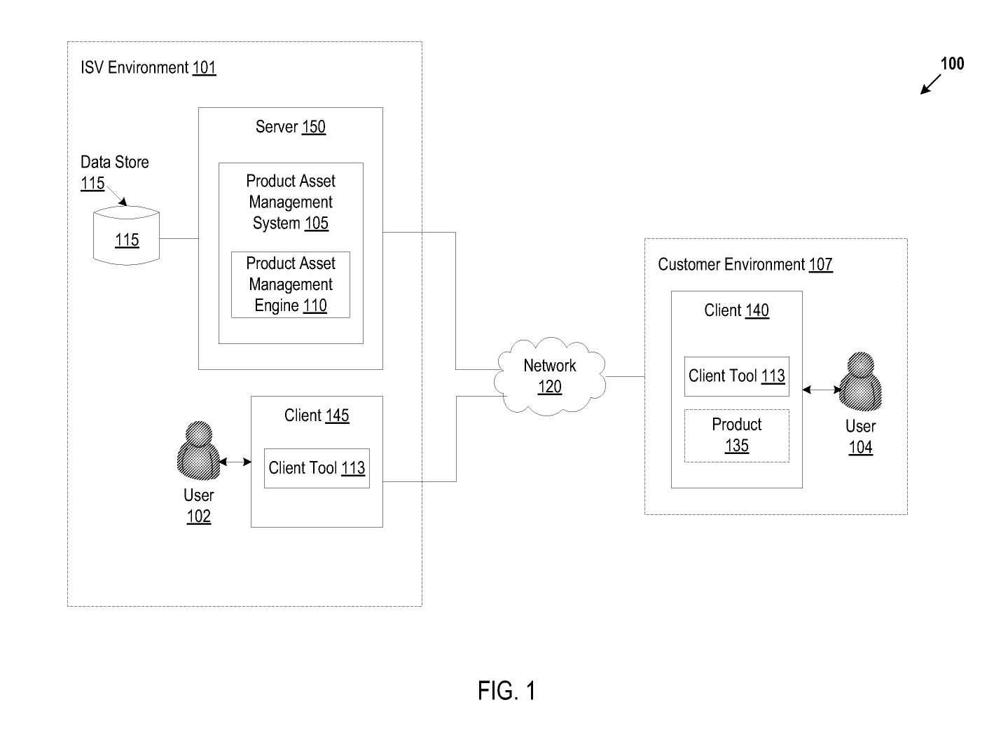

FIG. 1 is an exemplary network architecture 100 in which embodiments of the present invention can be implemented. The network architecture 100 can include a software provider environment, such as an independent software vendor (ISV) environment 101, communicating with one or more customer environments 107 via a network 120. A customer environment 107 includes one or more clients 140 communicating with the server 150 via the network 120. The network 120 can be a local area network (LAN), such as an intranet within a company, a wireless network, a mobile communications network, a wide area network (WAN), such as the Internet, or similar communication system. The network 120 can include any number of networking and computing devices such as wired and wireless devices.

Software providers can develop and/or sell software and/or service products. A software provider can be a large software company that develops and sells operating system platforms, an ISV that develops and sells specialized software to run on an operating system platform, and/or an independent service provider (ISP) that does not develop, but sells products. For brevity and simplicity, an ISV is used as an example of a software provider throughout this document.

Customers that purchase subscriptions are owners of the subscriptions. A subscription purchase is an owner's right to use the product for the period of the subscription. An owner's use of a subscription can be represented, for example, as an ‘entitlement.’ Software may or may not already be installed on an entity. Software that is already installed on an entity can be somewhat usable, even if the entity is not granted an entitlement for the installed software. When an entity is granted an entitlement for the software, the entity can access a product repository to receive software updates. For example, an ISV develops and sells Enterprise Software ABC. A customer, ACME Company, purchases ten 3-year subscriptions to Enterprise Software ABC, which is represented by ten entitlements. ACME Company may already have the Enterprise Software ABC installed in one or more of its systems. When a system is granted an entitlement for the Enterprise Software ABC the system can receive updates for the Enterprise Software ABC.

A consumer is an entity that has been granted an entitlement to allow the entity to receive product updates. For example, when an entity is granted an entitlement for the Enterprise Software ABC, the entity is a consumer of the Enterprise Software ABC. Examples of entities include, and are not limited to, a person, a client computing system, a server computing system, a domain, etc.

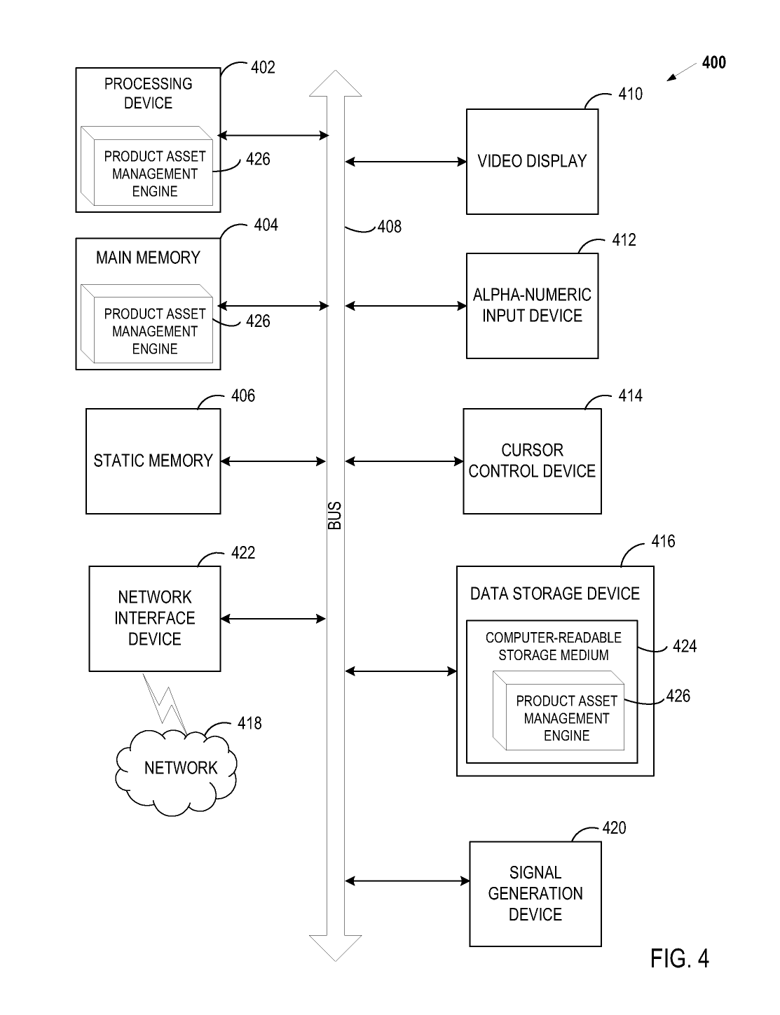

Software providers and customers can track which product subscriptions have been purchased and which of the purchased subscriptions have been consumed. The tracking of purchased and consumed products is hereinafter referred to as ‘product asset management.’ Product asset management can also include tools to manage the consumers in their environments. These tools may, for example, allow system administrators to manage patches, updates, monitoring and maintenance of the entitlements, etc. A software provider environment, such as ISV environment 101, can include a server 150 that hosts a product asset management system 105 for managing product assets in the one or more customer environments 107. The product asset management system 105 can include, for example, a Java web application based on a REST (Representational State Transfer) client-server architecture that exposes a REST API. A server 150 can be hosted by any type of computing device including server computers, gateway computers, desktop computers, laptop computers, hand-held computers or similar computing device. An exemplary computing device is described in greater detail below in conjunction with FIG. 4.

Conventional product asset management tools are hard-coded to support a specific product business model and do not offer flexibility in what can be managed. The product asset management system 105 can include a product asset management engine 110 that allows third parties (e.g., independent software vendor (ISV), independent service provider (ISP), etc.) to customize product business model data and to manage product assets as specified by the custom product business model data. The third party is a third party to a developer of the product asset management engine. Examples of product business model data can include, and are not limited to, subscription data, product data, entitlement data, identity data, event publishing data, user data, business rules, batch job data, etc. The product asset management engine 110 enables third parties to specify the product business model data that is of interest to the third party. For example, a third party, such as an ISV, can specify which products are to be managed and which business models to use. In one embodiment, the product asset management engine 110 replaces default product business model data with the custom product business model data of the third party.

The code of the product asset management engine 110 can include extension points to call extensions to enable third parties to specify the product business model data to use in managing product assets. An extension point is a predefined point in the program code (e.g., product asset management engine 110 code) to add extensions to customize behavior at that point. An extension is program code to extend the behavior of other program code at the extension points in the other program code. In one embodiment, the extensions are default extensions provided by the developer of the product asset management engine 110 to use default product business model data to manage product assets. In another embodiment, a third party develops and provides the extensions to specify custom product business model data to use in managing product assets. In that way, a third party needs only to integrate to these extension points to customize the functionality of the product asset management engine 110. In another embodiment, the product asset management engine 110 replaces the default extensions with the third party extensions. The product asset management engine 110 can be a Java-based engine that includes the extension points to call extensions (e.g., third party extensions, default extensions) at deployment time, to plug-in the product business model data of interest.

In one embodiment, the product asset management system 105 exposes a programmatic REST interface, which a client tool 113 hosted by a client 140,145 can communicate with. In one embodiment, a client tool 113 can be any kind of tool which could communicate with the REST interface. For example, a user 102, such as an ISV system administrator, can use the client tool 113 to communicate with the product asset management system 105 to manage product patches and product updates of the consumers in the one or more customer environments 107. In another example, ACME Company may be a customer, and its environment 107 can include one or more clients 140 that can communicate to the server 150 in the ISV environment 101. A user 104, such as an ACME Company system administrator, can use the client tool 113 to communicate with the product asset management system 105 to consume a product 135 on a client 140. Other examples of a client tool 113, can include and are not limited to, a web interface, web browser, or other client software that can communicate with the REST interface. The client machines 140,145 can be hosted by any type of computing device including server computers, gateway computers, desktop computers, laptop computers, mobile communications devices, cell phones, smart phones, hand-held computers, or similar computing device. An exemplary computing device is described in greater detail below in conjunction with FIG. 4.

A data store 115 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

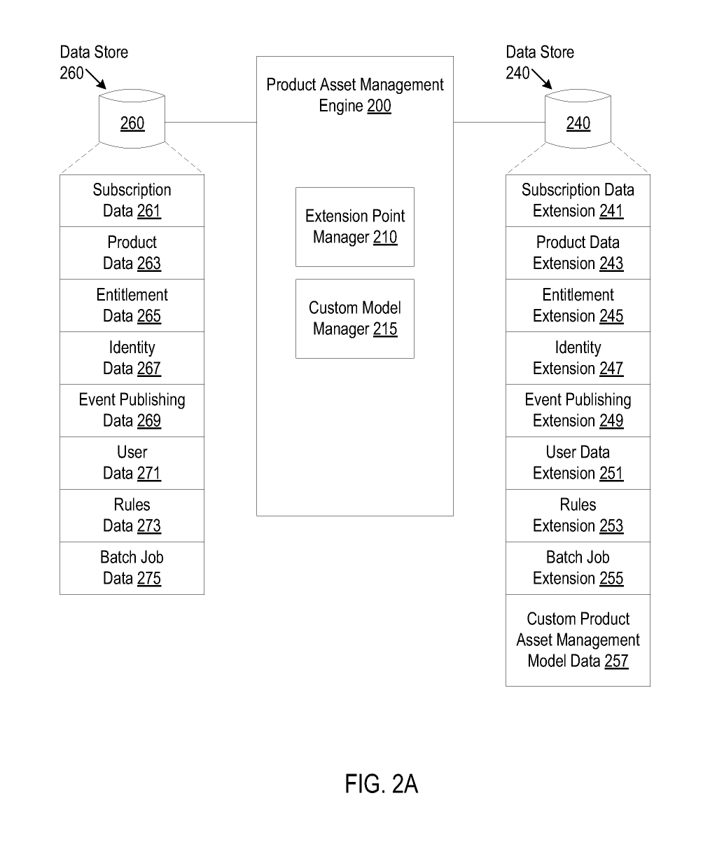

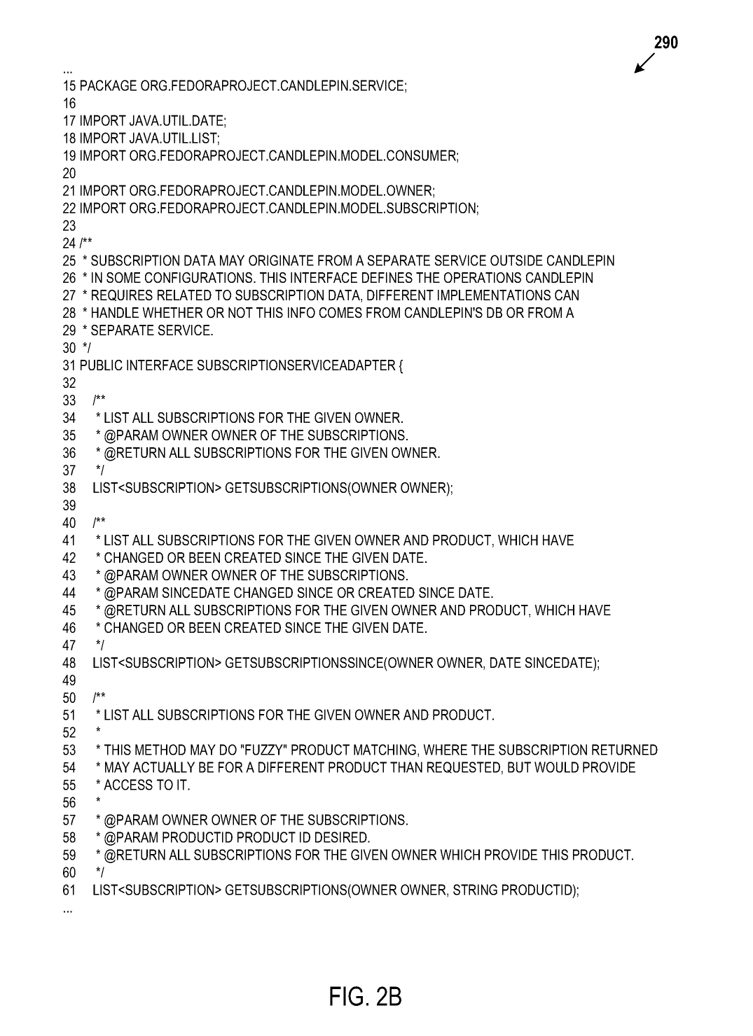

FIG. 2A is a block diagram of one embodiment of a product asset management engine 200 for allowing custom implementations to manage product assets as specified by a third party. The product asset management engine 200 can be the same as the product asset management engine 110 in a product management system 105 hosted by a server 150 of FIG. 1. The product asset management engine 200 can include an extension point manager 210 and a custom model manager 215.

A third party, such as an ISV, can provide and/or specify the product business model data to be used for managing product assets. Examples of product business model data can include, and are not limited to, subscription data 261, product data 263, entitlement data 265, identity data 267, event publishing data 269, user data 271, rules data 273, batch job data 275, etc. The product asset management engine 200 can be coupled to one or more data stores 260 that store the product business model data. The product business model data can be stored in one or more tables in a database. The product business model data can be existing internal data, for example, that is maintained by a sales department and/or accounting department of the third party.

Examples of subscription data 261 can include, and are not limited to, data representing the products that owners have purchased, the quantity of the purchased products, the time period the purchase is valid for, etc. Product data 263 defines the products to be managed and can include product attributes and the attribute values. Examples of product attributes can include, and are not limited to, the architecture types, the number of CPU sockets, the number of cores/CPU that are supported by a product. The entitlement data 265 is data that can define the representation of an entitlement to be granted to an entity. The identity data 267 can define how entities identify themselves with the product asset management system. For example, the identity data 267 can include identity certificates to assign to registered entities. Event publishing data 269 can define how the product asset management system should publish events. Example events can include, and are not limited to, create a consumer, update a consumer, delete a consumer, create an entitlement, update a subscription, etc. User data 271 can define how the product asset management system should authorize and authenticate users. Rules data 273 can specify (e.g., using pluggable Javascript) what is the “best” product for an entity to subscribe to and can control whether an entity can consume an entitlement to a subscribed product. Batch job data 275 can define how the product asset management system should handle batch jobs.

The product asset management engine 200 supports extension points to add extensions, such as third party extensions, to customize the behavior of the product asset management engine 200 at that particular point. The extension points relate to product business model data that is of interest to a third party, such as product business model data stored in data store 260. Examples of extension points can include, and are not limited to, a subscription data extension point, a product data extension point, a entitlement extension point, an identity extension point, an event pubishing extension point, a user data extension point, a rules extension point, a batch job extension point, etc.

Each extension point in the code of the product asset management engine 200 allows one or more extensions (e.g., extensions 241-255) to be attached to it. A third party can provide the extensions. An extension is program code (e.g., third party program code) to extend the behavior of other program code (e.g., product asset management engine 200 code) at the extension points in the other program code. The extensions written to adhere to a Java interface and deployed. A server (e.g., server 150 in FIG. 1) hosting the product asset management system can be configured, for example, via a configuration file, to use the deployed extensions. FIG. 2B illustrates a portion of an exemplary extension interface 290. A third party can write a subscription data extension (e.g., subscription data extension 241) to adhere to the interface 290. Returning to FIG. 2A, the product asset management engine 200 can be coupled to one or more data stores 240 that store the extensions. Examples of the extensions can include, and are not limited to a subscription data extension 241, a product data extension 243, an entitlement extension 245, an identity extension 247, an event publishing extension 249, a user data extension 251, a rules extension 253, a batch job extension 255, etc.

The product asset management engine 200 can detect a product asset management request relating to custom product business model data of a third party. Examples of product asset management requests can include, and are not limited to, a request for a list of subscriptions that are available to an entity based on the custom product business model data of the third party, a request for an entitlement for a particular product for an entity based on the custom product business model data of the third party, a request pertaining to managing patches, updates, monitoring and maintenance of the entitlements, etc. A request can be associated with one or more extensions points to obtain data for the request. For instance, the request can be for a list of subscriptions that are available to an entity. The request can be associated with a product data extension point to obtain product data 263 as specified by the third party and a subscription data extension point to obtain subscription data 261 as specified by the third party.

The extension point manager 210 can detect an extension point during execution of the product asset management engine 200 and execute a call for the extension that is associated with the extension point. The extension developer (e.g., third party) provides metadata about an extension. The extensions (e.g., extensions 241-255) are registered during runtime so that the extension point manager 210 can discover them for use at a corresponding extension point in the code of the product asset management engine. A server hosting the product asset management system can be configured, for example, via a configuration file, to use the registered extensions. For example, a subscription data extension 241 can be associated to a subscription data extension point. The extension point manager 210 can detect the subscription data extension point and use the metadata of the subscription data extension 241 to invoke the subscription data extension 241. An example of a subscription data extension 241 is one, which when invoked, can identify the location of subscription data 261 to be used to manage product assets. An example of a product data extension 243 is one, which when invoked, can identify the location of product data 263 to be used to manage product assets. An example of an entitlement extension 245 is one, which when invoked, can generate a flat file representation of an entitlement based on entitlement data 265. An example of an identity extension 247 is one, which when invoked, can generate a consumer's identity data. For instance, an identity extension 247 can assign and send an identity certificate from identity data 267 to an entity, which the entity can subsequently use to authenticate itself when communicating with the product asset management system.

An example of an event publishing extension 249 is one, which when invoked, can publish business events which occur in the product asset management system based on event publishing data 269. An example of a user data extension 251 is one, when invoked, can authorize and authenticate users based on user data 271. An example of a rules extension 253 is one, which when invoked, can execute pluggable Javascript to, for example, generate a list of product subscriptions that are available to an entity, data indicating whether an entitlement for a product is granted to the entity, etc., based on the product data 263 and subscription data 261. An example of a batch job extension 255 is one, which when invoked, can cluster batch jobs based on batch job data 275.

The custom model manager 215 can use the results from invoking extensions to service the product asset management request. For instance, when the product asset management request is for a list of subscriptions that are available to an entity, the custom model manager 215 can use the results from invoking a product data extension 243, a subscription data extension 241, and a rules extension 253 to provide a client (e.g., client 140 in FIG. 1) data for the list. The client can receive the data and present the list of subscriptions that are available to an entity to a user.

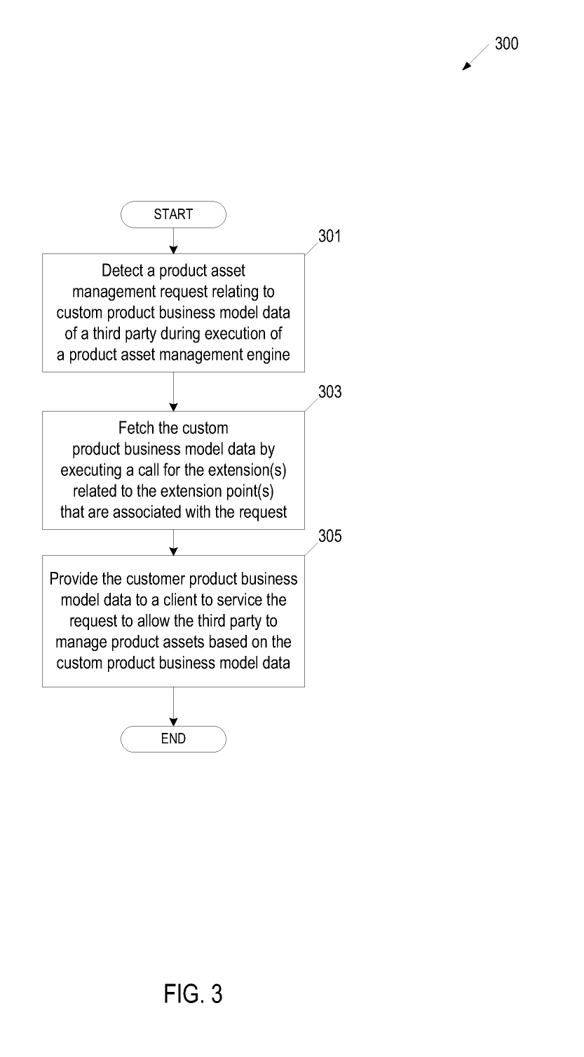

FIG. 3 is a flow diagram of an embodiment of a method 300 for allowing custom implementations to manage product assets as specified by a third party. Method 300 can be performed by processing logic that can comprise hardware (e.g., circuitry, dedicated logic, programmable logic, microcode, etc.), software (e.g., instructions run on a processing device), or a combination thereof. In one embodiment, method 300 is performed by the product asset management engine 110 hosted by a server 150 of FIG. 1.

In one embodiment, the method 300 starts with execution of the product asset management engine. At block 301, the product asset management engine detects a product asset management request that relates to custom product business model data of a third party, such as subscription data, product data, entitlement data, identity data, event publishing data, user data, business rules, batch job data, etc. The third party is a third party to a developer of the product asset management engine. A request can be associated with one or more extensions points to fetch data for the request. For instance, the request can a request for a list of subscriptions available to an entity and can be associated with a subscription data extension point, product data extension point, and rules extension point to obtain subscription data, product data, and rules as specified by the third party.

At block 303, the product asset management engine fetches the custom product business model data by executing a call for the extensions relating to the extension points to obtain custom product business model data. The third party extension developer provides metadata about the extension. The extensions are registered during runtime so that they may be discovered for use at a corresponding extension point in the code of the product asset management engine. A server hosting the product asset management system can be configured, for example, via a configuration file, to use registered extensions. One common use of the metadata is to specify the object type that a given extension class can process. The product asset management engine can use the metadata for the registered extensions to determine an extension capable of supporting the object presented at the extension point for processing. The product asset management engine then invokes the extension to process the object and uses the results from invoking the extension to service the product asset management request at block 305. For example, a request for a list of subscriptions available to an entity is associated with a subscription data extension point, product data extension point, and rules extension point to obtain subscription data, product data, and rules as specified by the third party. The product asset management engine invokes the subscription data extension, the product extension, and the rules extension. The subscription data extension executes to identify the location of the subscription data of interest to the third party, the product data extension executes to identify the product data to use, and the rules extension executes to apply business rules as specified by the third party. The product asset management system can use the results from calling the extensions to service the product asset management request. For instance, the product asset management engine uses the product data, the subscription data, and the rules to provide data to a client for a list of subscriptions that are available to an entity.

FIG. 4 is a diagram of one embodiment of a computer system for allowing custom implementations to manage product assets as specified by a third party. Within the computer system 400 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client machine (e.g., a client computer executing the browser and the server computer executing the automated task delegation and project management) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) such as synchronous DRAM (SDRAM) or DRAM (RDRAM), etc.), a static memory 406 (e.g., flash memory, static random access memory (SRAM), etc.), and a secondary memory 416 (e.g., a data storage device in the form of a drive unit, which may include fixed or removable computer-readable storage medium), which communicate with each other via a bus 408.

Processing device 402 represents one or more general-purpose processing devices such as a microprocessor, central processing unit, or the like. More particularly, the processing device 402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute the product asset management engine 426 for performing the operations and steps discussed herein.

The computer system 400 may further include a network interface device 422. The computer system 400 also may include a video display unit 410 (e.g., a liquid crystal display (LCD) or a cathode ray tube (CRT)) connected to the computer system through a graphics port and graphics chipset, an alphanumeric input device 412 (e.g., a keyboard), a cursor control device 414 (e.g., a mouse), and a signal generation device 420 (e.g., a speaker).

The secondary memory 416 may include a machine-readable storage medium (or more specifically a computer-readable storage medium) 424 on which is stored one or more sets of instructions (e.g., the product asset management engine 426) embodying any one or more of the methodologies or functions described herein. The product asset management engine 426 may also reside, completely or at least partially, within the main memory 404 and/or within the processing device 402 during execution thereof by the computer system 400, the main memory 404 and the processing device 402 also constituting machine-readable storage media. The product asset management engine 426 may further be transmitted or received over a network 418 via the network interface device 422.

The computer-readable storage medium 424 may also be used to store the product asset management engine 426 persistently. While the computer-readable storage medium 424 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The product asset management engine 426, components and other features described herein (for example in relation to FIG. 1) can be implemented as discrete hardware components or integrated in the functionality of hardware components such as ASICS, FPGAs, DSPs or similar devices. In addition, the product asset management engine 426 can be implemented as firmware or functional circuitry within hardware devices. Further, the product asset management engine 426 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “detecting,” “obtaining,” “providing,” “presenting,” “storing,” “replacing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus can be specially constructed for the required purposes, or it can comprise a general purpose computer system specifically programmed by a computer program stored in the computer system. Such a computer program can be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of embodiments of the invention as described herein.

A computer-readable storage medium can include any mechanism for storing information in a form readable by a machine (e.g., a computer), but is not limited to, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

Thus, a method and apparatus for allowing custom implementations to manage product assets as specified by a third party is described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, implemented by a server computing system programmed to perform the following, comprising:
detecting, by the server computing system, a product asset management request relating to custom product business model data of a third party during execution of a product asset management engine, wherein the third party is a third party to a developer of the product asset management engine, and wherein the request is associated with at least one extension point;
obtaining, by the server computing system, the custom product business model data by executing a call for an extension relating to the at least one extension point;
providing, by the server computing system, the custom product business model data to a client to service the request to allow the third party to manage product assets as specified by the third party.

2. The method of claim 1, wherein the at least one extension point comprises a service call for at least one of: subscription data pertaining to the third party, product data pertaining to the third party, entitlement data pertaining to the third party, identity data pertaining to the third party, user data pertaining to the third party, event publishing data pertaining to the third party, and business rules pertaining to the third party.

3. The method of claim 1, wherein providing the custom product business model data to the client comprises:
providing data for a list of product subscriptions that are available to an entity based on the custom product business model data for the third party.

4. The method of claim 1, wherein providing the custom product business model data to the client comprises:
providing data indicating whether an entitlement is granted to an entity based on the custom product business model data for the third party.

5. The method of claim 1, further comprising:
storing at least one extension relating to product business model data of the third party.

6. The method of claim 1, further comprising:
replacing default product business model data with the custom product business model data of the third party.

7. A system comprising:
a persistent storage unit to store program code of a product asset management engine comprising at least one extension point relating to custom product business model data of a third party, wherein the third party is a third party to a developer of the product asset management engine; and
a processor coupled to the persistent storage unit to execute the program code of the product asset management engine, to detect a product asset management request relating to the custom product business model data of the third party during execution of the product asset management engine, wherein the request is associated with at least one extension point, to obtain custom product business model data by executing a call for an extension relating to the at least one extension point, and to provide the custom product business model data to a client to service the request to allow the third party to manage product assets as specified by the third party.

8. The system of claim 7, wherein the at least one extension point relating to product business model data comprises a service call for at least one of: subscription data pertaining to the third party, product data pertaining to the third party, entitlement data pertaining to the third party, identity data pertaining to the third party, user data pertaining to the third party, event publishing data pertaining to the third party, and business rules pertaining to the third party.

9. The system of claim 7, wherein to provide the custom product business model data comprises the processor:
to provide data for a list of product subscriptions that are available to an entity based on the custom product business model data for the third party.

10. The system of claim 7, wherein to provide the custom product business model data comprises the processor:
to provide data indicating whether an entitlement is granted to an entity based on the custom product business model data for the third party.

11. The system of claim 7, further comprising the persistent storage unit:
to store at least one extension relating to the product business model data of the third party.

12. The system of claim 7, further comprising the processor:
to replace default product business model data with the custom product business model data of the third party.

13. A non-transitory computer-readable storage medium including instructions that, when executed by a computer system, cause the computer system to perform a set of operations comprising:
detecting, by the server computing system, a product asset management request relating to custom product business model data of a third party during execution of a product asset management engine, wherein the third party is a third party to a developer of the product asset management engine, and wherein the request is associated with at least one extension point;
obtaining, by the server computing system, the custom product business model data by executing a call for an extension relating to the at least one extension point;
providing, by the server computing system, the custom product business model data to a client to service the request to allow the third party to manage product assets as specified by the third party.

14. The non-transitory computer-readable storage medium of claim 1, wherein the at least one extension point comprises a service call for at least one of: subscription data pertaining to the third party, product data pertaining to the third party, entitlement data pertaining to the third party, identity data pertaining to the third party, user data pertaining to the third party, event publishing data pertaining to the third party, and business rules pertaining to the third party.

15. The non-transitory computer-readable storage medium of claim 1, wherein providing the custom product business model data comprises:
providing data for a list of product subscriptions that are available to an entity based on the custom product business model data for the third party.

16. The non-transitory computer-readable storage medium of claim 1, wherein providing the custom product business model data comprises:
providing data indicating whether an entitlement is granted to an entity based on the custom product business model data for the third party.

17. The non-transitory computer-readable storage medium of claim 1, further comprising:
storing at least one extension relating to the product business model data of the third party.

18. The non-transitory computer-readable storage medium of claim 1, further comprising:
replacing default product business model with the custom product business model data of the third party.
